(19) United States
(12) Patent Application Publication
(10) Pub. No.: US 2014/0307306 A1
(43) Pub. Date: Oct. 16, 2014

(54) Redirection of Far-Infrared Energy Away From Patients Receiving Light Therapy

(71) Applicants: David B. Anderson, Concord, MI (US); David J. Arndt, Milan, MI (US); Brian E. Gorrell, Butler, IN (US)

(72) Inventors: David B. Anderson, Concord, MI (US); David J. Arndt, Milan, MI (US); Brian E. Gorrell, Butler, IN (US)

(21) Appl. No.: 13/861,817

(22) Filed: Apr. 12, 2013

(51) Int. Cl. G02B 5/20

(52) U.S. Cl. CPC G02B 5/208
USPC 359/350

(57) ABSTRACT

One embodiment to redirect far-infrared energy away from a patient receiving light therapy is a unit housing (1) with an internal reflective surface (5) to re-direct waste heat emitted from a light therapy emitter (7) that is conducted and radiated by a heat sink (3) back to the heat sink (3) for re-radiation through radiance openings (6) in the unit housing (1).

Use of a cooling fan is eliminated and air convection cooling is secondary to removal of heat by radiance, thereby enabling light therapy to be delivered in sterile environments without the light therapy device being subjected to sterilization processes since the light therapy device can be wrapped or bagged in a sterile covering without overheating.

Other embodiments are described and anticipated.

### CROSS-REFERENCE TO RELATED APPLICATIONS

The present application claims the benefit of provisional patent application EFS ID# 12533244 filed on 2012 Apr. 12 by the present inventors.

### BACKGROUND—PRIOR ART

| Patent Number | Kind Code | Publication date | Patentee |
|---|---|---|---|
| EP2152364 | B1 | Aug. 22, 2012 | Voves |
| EP2310092 | A1 | Apr. 20, 2011 | Perez |
| US20060020308 | A1 | Jan. 26, 2006 | Muldner |

Light-emitting diodes (LED's), whether generating coherent (laser) or non-coherent light, produce waste heat due to inefficiencies in the conversion of electricity into the desired wavelength(s) of light. Manufacturers of light therapy devices with substantial light energy output typically remove waste heat by incorporating at least one electric fan into their design. At least one cooling fan continues to be the standard solution to the problem of how to remove heat from light therapy devices and prevent excess heat from reaching a patient.

Fans collect dirt and dust on their blades and are prone to failure as bearings wear out. The ability of fans to provide cooling diminishes over time as the rate of air flow drops, thus reducing the useful life of the light therapy device.

Fans used for cooling LED's produce noise which tends to get worse with age. When used for veterinary light therapy, devices with fan noise can cause distress to animals, making treatment more difficult if not impossible to perform.

Light therapy devices with a fan or fans need to move air to provide cooling, limiting their use in situations requiring a sterile environment such as hospital operating room, where sterile bags or wraps would prevent sufficient air flow from being achieved. When used in an operating room sterile environment a fan-cooled light therapy device has to be sterilized after each use. Some fan-cooled light therapy devices cannot withstand a sterilization process and are not usable in a sterile environment.

Convection-cooled light therapy devices used in sterile environments suffer from the same limitations as fan-cooled light therapy devices due to restricted air movement when sealed or wrapped in sterile materials.

### SUMMARY

In accordance with one embodiment a light therapy device will redirect far-infrared heat away from a patient's treatment site using a combination of conductance, insulation, reflectance, absorption and re-radiance.

### Advantages

Accordingly, several advantages of one or more aspects are as follows: no moving mechanical parts to wear out, more stable cooling capacity over time, reduced heat felt by patient, silent light therapy treatments lower animal stress, ability to cool through radiance allows light therapy to be given in sterile environments with sealed bags or wraps. Other advantages of one or more aspects will be apparent from a consideration of the drawings and ensuing description.

### DRAWINGS—FIGURES

FIG. 1 shows the various aspects of an insulated heat sink in close proximity to a reflective surface from the non-light-emitting side of a light therapy device in accordance with one embodiment.

FIG. 2 shows an exploded one-side-view of a light therapy device unit housing and associated parts to insulate, reflect and allow radiated far-infrared energy to escape in accordance with one embodiment.

Drawings-Reference Numerals

| | | | |
|---|---|---|---|
| 1 | unit housing | 2 | insulating collar washer |
| 3 | heat sink | 4 | insulating washer |
| 5 | reflective surface | 6 | radiance opening |
| 7 | light therapy emitter | 8 | mounting screw |

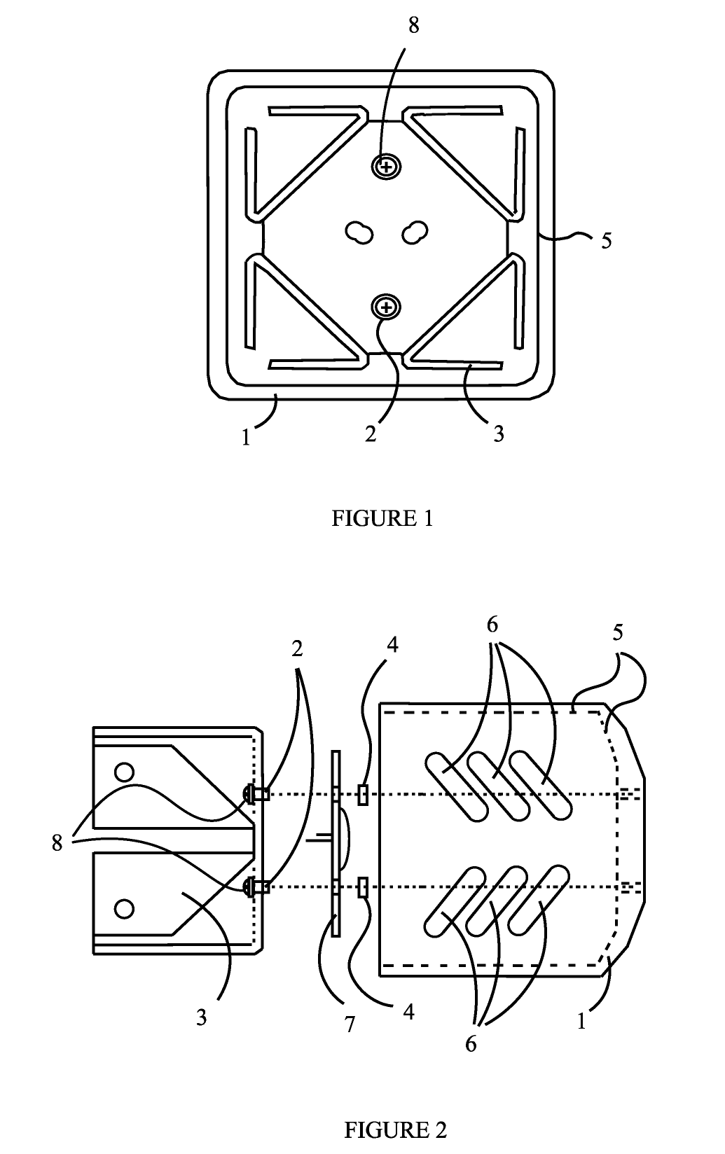

### DETAILED DESCRIPTION—FIGS. 1 AND 2

### First Embodiment

One embodiment of redirection of far-infrared energy away from a patient receiving light therapy is illustrated in FIGS. 1 and 2. A unit housing (1) available from DavaRay, Inc. of Ann Arbor, Mich. has a shape which surrounds a folded-fin heat sink (3) available from Aavid Thermalloy of Concord, N.H. A reflective surface (5) on the interior of the unit housing (1) faces the heat sink (3) to reflect heat radiated by the heat sink (3) back to the heat sink (3) for re-absorption and to be re-radiated through radiance openings (6). A light therapy emitter (7) in a standard TO-66 case available from Roithner LaserTechnik of Vienna, Austria with applied thermally conductive compound routinely used for heat-generating electronic components is mounted to the unit housing (1) and heat sink (3) using 2 standard size 10 mounting screws (8) each passing first through an insulating collar washer (2) available from Eagle Plastic Devices of Mansfield, Tex., further passing through the heat sink (3) then passing through the light therapy emitter (7), further passing through an insulating washer (4) available from Eagle Plastic Devices of Mansfield, Tex., then affixed to the unit housing (1).

The unit housing (1) is made from aluminum which is anodized and then milled on the inside to create a reflective surface (5). However, the unit housing (1) can also be made without anodizing, and from other metals, plastics, woods, various fibrous products, printed on a 3-D printer with various metals, plastics, vinyl, nylon, etc. in various layers. The reflective coating (5) can also be obtained by polishing, or applied as a coating on, the inside of the unit housing (1). The insulating collar washer (2) can be made of any material resistive to thermal-conduction such as plastic, nylon, paper, cardboard, various plasticized materials, various impregnated or laminated fibrous materials, etc.

The heat sink (3) is made from black anodized aluminum, however it could also be made of thermally conductive plastic or other metal and/or other color as long as the heat sink (3) is of sufficiently low thermal resistance to remove heat from the light therapy emitter (7) at a rate which protects the light therapy emitter (7) from thermal damage. Other heat sink (3) shapes such as round, oblong, parallel fins, rectangular, triangular, hexagonal, octagonal, etc. are acceptable provided they are capable or removing heat at a rate which protects the light therapy emitter (7) from thermal damage.

Radiance openings (6) are of sufficient size and shape to allow the heat sink (3) sufficient area to radiate heat when convection air currents are not available such as when encased in sterile bags or wraps. The position of the heat sink (3) relative to the at the light therapy emitter (7) side of the unit housing (1) is at least 2 mm, however this distance can be greater.

The insulating washers (4) can be made of any non-thermally-conductive material such as plastic, nylon, paper, cardboard, various plasticized materials, various impregnated or laminated fibrous materials, etc.

### OPERATION—FIGS. 1, 2

The manner of operation is to passively (with no moving parts) redirect light therapy emitter (7) waste heat felt by patients receiving light therapy, by reducing the amount of heat absorbed and radiated toward the patient from the patient-facing side of the unit housing (1). The heat sink (3) conducts heat away from the light therapy emitter (7) and radiates a portion through radiance openings (6) and a portion is radiated in the direction of the reflective surface (5) which reflects heat back to the heat sink (3) or out through the radiance openings (6). Heat re-absorbed by the heat sink (3) is conducted to other areas of the heat sink (3) and re-radiated, continuing the cycle until it escapes through the radiance openings (6).

### CONCLUSION, RAMIFICATIONS, AND SCOPE

Accordingly, the reader will see that the method and means to redirect far-infrared energy away from patients receiving light therapy by using a combination of insulating, conducting, radiating, reflecting, re-absorbing, and re-radiating, allowing the elimination of cooling fans in light therapy devices. Furthermore, redirecting far-infrared energy without using a fan (or fans) or relying on convection air currents has additional advantages in that light therapy devices can be used in sterile environments, have greater reliability, and can operate quietly.

Although the above description contains many specificities, these should not be construed as limiting the scope of the embodiments but as merely providing illustrations of some of several embodiments. For example, the unit housing, heat sink, radiance openings, may have other shapes, such as circular, rectangular, oblong, trapezoidal, triangular, etc.; the light therapy emitter may be a single or multiple array of coherent or non-coherent emitter(s) in a different electronic case type; the materials used may be metals, plastics, woods, various fibrous products, printed on a 3-D printer with various metals, plastics, vinyl, nylon, etc. in various layers.

Thus the scope of the embodiments should be determined by the appended claims and their legal equivalents, rather than by the examples given.

1. An apparatus for redirecting far-infrared energy away from the intended direction of therapeutic light energy, comprising:
(a) an insulating washer between a light therapy emitter and a unit housing; and
(b) a heat sink of sufficiently low thermal resistance attached to said light therapy emitter; and
(c) a reflective surface on all interior surfaces of said unit housing facing said heat sink; and
(d) a set of radiance openings with a combined area equal to at least 20% of the surface area of said heat sink facing said unit housing

2. The apparatus of claim 1, wherein the distance between the reflective surface of the interior of the unit housing and the heat sink is at least 2 mm.

3. The apparatus of claim 1, wherein the radiating surface of said heat sink is positioned parallel to the openings.

4. The apparatus of claim 1, wherein at least 50% of the exterior area of the heat sink is within 10 mm of the unit housing's reflective surface.

5. The apparatus of claim 1, wherein the light therapy emitter is in the near-infrared range.

6. The apparatus of claim 1, wherein the light therapy emitter is in the ultra-violet range.

7. The apparatus of claim 1, wherein the light therapy emitter is in the visible range.

8. The apparatus of claim 1, wherein the light therapy emitter is has multiple ranges in any of the near-infrared, visible, or ultra-violet ranges.

9. A method for redirecting far-infrared energy away from the intended direction of therapeutic light energy, comprising:
a reflective surface redirects unwanted heat energy from a heat sink source back to said heat sink source,
said reflective surface redirects unwanted heat energy from a light therapy emitter back to said light therapy emitter,
said heat sink directs unwanted heat energy to a plurality of radiance openings,
whereby said radiance openings allow unwanted heat energy to escape in a desired direction.
